(19) United States
(12) Patent Application Publication
(10) Pub. No.: US 2024/0178494 A1
(43) Pub. Date: May 30, 2024

(54) ELECTRICAL STORAGE DEVICE

(71) Applicant: Prime Planet Energy & Solutions, Inc., Tokyo (JP)

(72) Inventor: Ryoichi WAKIMOTO, Kobe-shi (JP)

(21) Appl. No.: 18/490,755

(22) Filed: Oct. 20, 2023

(30) Foreign Application Priority Data
Nov. 29, 2022 (JP) 2022-190521

(51) Int. Cl. H01M 50/188; H01M 10/658; H01M 50/103

(52) U.S. Cl. CPC H01M 50/188; H01M 10/658; H01M 50/103

(57) ABSTRACT

Provided is an electrical storage device, having high reliability of sealing properties in the vicinity of a through hole. The electrical storage device disclosed herein includes an electrode body, a case, and a first current collecting member. The case includes a first wall having a first through hole. The first current collecting member has a first region placed along the inner surface of the first wall. A projection part, projecting to the first wall, is in the first region. A part of the projection part is in the first through hole. The first current collecting member has a first slit is between the first region and a second region on the opposite site of the first side. The second region is placed along the inner surface of the first wall. The second region faces the inner surface of the first wall with the insulating member therebetween.

### CROSS REFERENCE TO RELATED APPLICATION

The present application claims the priority based on Japanese Patent Application No. 2022-190521 filed on Nov. 29, 2022, the entire contents of which are incorporated in the present specification by reference.

### BACKGROUND OF THE DISCLOSURE

### 1. Field

The present disclosure relates to an electrical storage device.

### 2. Background

Japanese Unexamined Patent Application Publication No. 2021-086813 discloses a technique for sealed batteries. Current collecting terminals included in the sealed batteries have an electrode body-connecting part, an outside connecting part, and an axial part located between the electrode body-connecting part and the outside connecting part. The electrode body-connecting part is connected to an electrode body accommodated in the inside of a case member. The outside connecting part is placed on the outside of the case member. The axial part is inserted into a terminal attachment hole provided in the case member. An insulating member is placed between the current collecting terminal and the terminal attachment hole. The insulating member is integrally molded with the current collecting terminal and the case member. Because of this, it is thought that an electrode can be easily taken out to the outside of the case member without a process of joining terminals or the like.

### SUMMARY

The present inventors have considered reducing the number of parts forming a conductive path from an electrode body accommodated in the inside of the case of an electrical storage device (e.g., battery) to a terminal on the outside of the case. At this time, the reliability of sealing properties in the vicinity of a through hole provided to provide the conductive path between the inside and the outside of the case can be a problem.

According to the present disclosure, there is provided an electrical storage device, including an electrode body including a first electrode and a second electrode, a case to accommodate the electrode body, and a first current collecting member electrically connected to the first electrode. The case has a first wall, and the first wall has a first through hole. The first current collecting member has a first region placed along the inner surface of the first wall, a projection part projecting to the first wall is provided in the first region, and at least part of the projection part is placed in the first through hole. The first current collecting member has a second region on the transverse side of the first region, and a first slit is formed between the first region and the second region. The second region is placed along the inner surface of the first wall, and the second region faces the inner surface of the first wall with an insulating member therebetween.

According to such a structure, because the first slit is provided in the first current collecting member, the insulating member easily enters the first slit, and the sealing properties in the periphery of the first through hole can be improved.

### BRIEF DESCRIPTION OF THE DRAWINGS

FIG. 1 is a perspective view schematically showing the structure of an electrical storage device according to one embodiment;

FIG. 2 is a longitudinal sectional view schematically showing the structure of an electrical storage device according to one embodiment;

FIG. 3 is a cross-sectional view taken along the line III-III in FIG. 2;

FIG. 4 is a cross-sectional view taken along the line IV-IV in FIG. 2;

FIG. 5 is a perspective view schematically showing an electrode body group attached to a sealing plate;

FIG. 6 is a perspective view schematically showing an electrode body to which a second positive current collecting part and a second negative current collecting part are attached;

FIG. 7 is a schematic diagram showing the structure of an electrode body according to one embodiment;

FIG. 8 is a perspective view schematically showing the structure of a first current collecting member according to one embodiment;

FIG. 9 is a perspective view schematically showing a structure in the vicinity of a first through hole of the sealing plate to which the first current collecting member is attached according to one embodiment;

FIG. 10 is a perspective view of the structure in the vicinity of the sealing plate to which the first current collecting member shown in FIG. 9 is attached when viewed from the inner surface side of the sealing plate;

FIG. 11 is a cross-sectional view taken along the line XI-XI in FIG. 9;

FIG. 12 is a cross-sectional view taken along the line XII-XII in FIG. 9; and

FIG. 13 is a corresponding diagram of FIG. 12 on a battery according to another embodiment.

### DESCRIPTION OF THE EMBODIMENTS

Some suitable embodiments of the technique disclosed herein will now be described with reference to drawings. It should be noted that things other than matters particularly mentioned in the specification, which are necessary to implement the present disclosure (for example, general structures and production processes for batteries which do not characterize the present disclosure) can be understood as design matters of those skilled in the art based on conventional techniques in the art. The present disclosure can be implemented based on the contents disclosed in the specification and technical knowledge in the art. It should be noted that the notation of “A to B (A and B are arbitrary values here)” showing a range in the specification means “A or more and B or less” and also encompasses the meanings of “above A and less than B,” “above A and B or less” and “A or more and less than B.”

It should be noted that the “electrical storage device” in the specification indicates a device which can be charged and discharged. Batteries such as primary batteries and secondary batteries (e.g., lithium ion secondary batteries and nickel hydrogen batteries) and capacitors such as an electric double-layer capacitor (physical battery) are encompassed in the electrical storage device. This technique will now be described using as an example a lithium ion secondary battery, one embodiment of the electrical storage device disclosed herein.

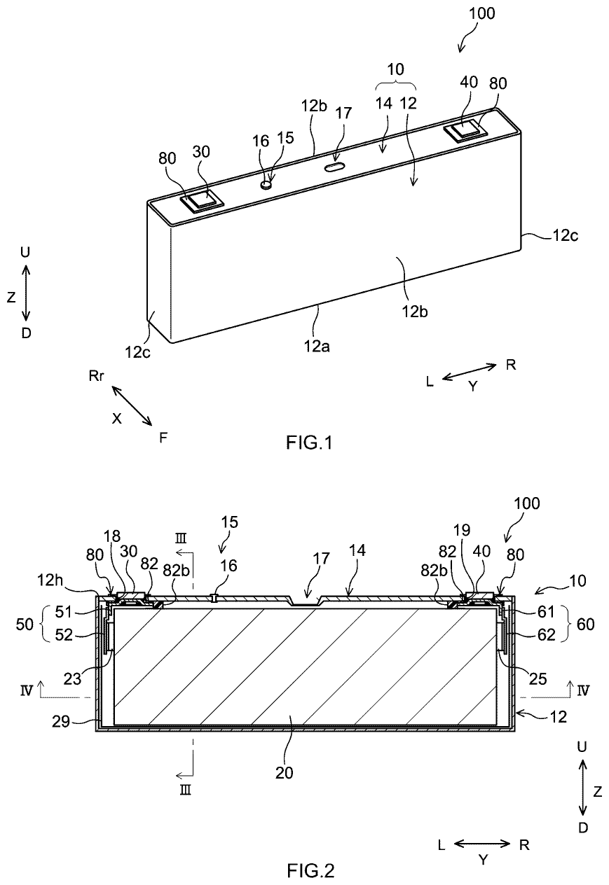

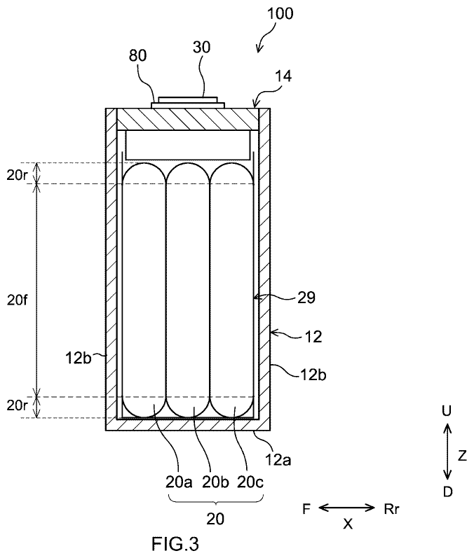

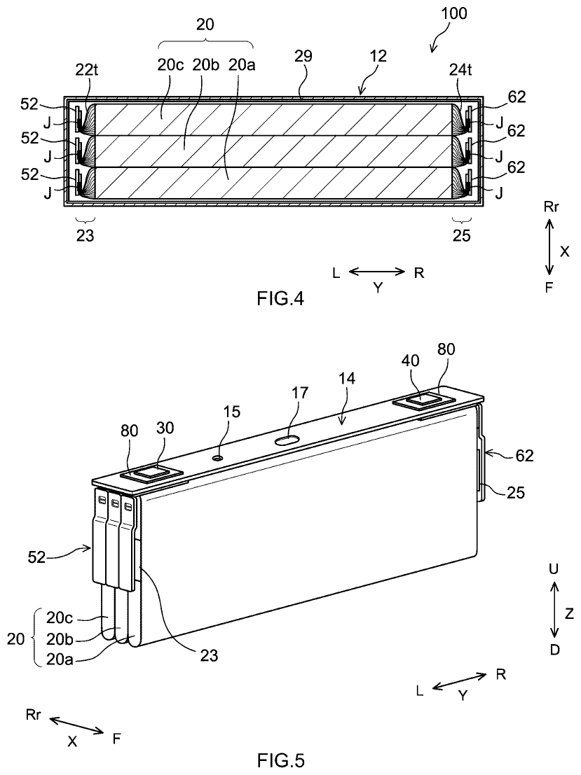

FIG. 1 is a perspective view schematically showing the structure of an electrical storage device 100 (hereinafter, also referred to as battery 100). FIG. 2 is a longitudinal sectional view schematically showing the structure of the battery 100. FIG. 3 is a cross-sectional view taken along the line III-III in FIG. 2. FIG. 4 is a cross-sectional view taken along the line IV-IV in FIG. 2. In the following description, signs L, R, F, Rr, U and D in the diagrams represent left, right, front, rear, upside and downside, respectively, and signs X, Y and Z in the diagrams represent the short side direction of the battery 100, the long side direction perpendicular to the short side direction and vertical direction, respectively. However, these are only directions for convenient explanation, and do not limit the setting forms of the battery 100.

As shown in FIG. 2, the battery 100 according to the present embodiment includes a case 10, an electrode body group 20, a positive terminal member 30, a negative terminal member 40, a positive current collecting part 50, a negative current collecting part 60, and an insulating member 80. The battery 100 according to the present embodiment further includes an electrolyte solution, which is not shown. The electrode body 20a included in the electrode body group 20 includes a first electrode and a second electrode. The first electrode can be a positive electrode or a negative electrode, and in the present embodiment, the first electrode is the positive electrode. The second electrode is a positive electrode or a negative electrode, and an electrode different from the first electrode. In the present embodiment, the second electrode is the negative electrode.

The case 10 is a housing to accommodate one or two or more electrode bodies (the electrode body group 20 here). The case 10 has the external shape of a cuboid (square shape) which is flat and has a bottom here. The material of the case 10 may be the same as those which have been conventionally used, and is not particularly restricted. The case 10 is preferably made of metal having a predetermined strength, and can be formed, for example, from aluminum, an aluminum alloy, iron, an iron alloy or the like. It should be noted that the shape of the case 10 is not limited to a square shape, and may be cylindrical or polyhedral.

The case 10 has a hexahedron shape having 6 walls. As shown in FIG. 1, the case 10 includes the first wall 14 as the upper wall, the almost rectangular bottom wall 12a facing the first wall 14, a pair of the first side walls 12b extended from the long side of the bottom wall 12a towards the upper side U and facing each other, and a pair of the second side walls 12c extended from the short side of the bottom wall 12a towards the upper side U and facing each other. The first wall 14 is formed into an almost rectangular shape here. The area of the second side wall 12c is smaller than the area of the first side wall 12b. In the present embodiment, the case 10 includes an outer case 12 including the bottom wall 12a, the first side wall 12b and the second side wall 12c, and a sealing plate as the first wall 14 (hereinafter, also referred to as sealing plate 14). It should be noted that the first wall is not limited to the sealing plate 14 and may be any of walls included in the case 10.

The outer case 12 is a flat square (hexahedral) container, in which one surface is an opening 12h. The opening 12h is formed on the upper surface of the outer case 12 surrounded by the pair of the first side walls 12b and the pair of the second side walls 12c. The sealing plate 14 is attached to the outer case 12 so that the opening 12h of the outer case 12 will be closed. The sealing plate 14 is an almost rectangular plate material in a planar view. The case 10 is formed by joining (e.g., welding joint) the sealing plate 14 in the periphery of the opening 12h in the outer case 12. The sealing plate 14 can be joined, for example, by welding such as laser welding.

As shown in FIG. 1 and FIG. 2, a gas release valve 17 is provided in the sealing plate 14. The gas release valve 17 is opened when the pressure in the case 10 is equal to or larger than a predetermined value, to release gas in the case 10.

In addition to the gas release valve 17, an injection hole 15, a first through hole 18 and a second through hole 19 are provided in the sealing plate 14. The injection hole 15 is communicated with the internal space of the case 10, and is an opening provided to inject an electrolyte solution in the step of producing the battery 100. The injection hole 15 is sealed with a sealing member 16. For such sealing member 16, for example, a blind rivet is suitable. Because of this, the sealing member 16 can be rigidly fixed in the inside of the case 10.

The first through hole 18 has a size into which part of the positive terminal member 30 or the positive current collecting part 50 can be inserted, and the shape thereof is not particularly limited. The first through hole 18 can be, for example, in a circle, ellipse, square, quadrilateral such as a rectangle, or polygon shape in a planar view. The angular parts of the first through hole 18 may be round chamfered. Here, the first through hole 18 is provided to be in a rectangular shape the angular parts of which are round chamfered in a planar view. The shape of the second through hole 19 is not particularly limited as long as it has a size into which part of the negative terminal member 40 or the negative current collecting part 60 can be inserted. The shape of the second through hole 19 may be the same as of the first through hole 18.

FIG. 5 is a perspective view schematically showing the electrode body group 20 attached to the sealing plate 14. In the present embodiment, (here, three) electrode bodies 20a, 20 b and 20c are accommodated in the inside of the case 10. It should be noted that the number of electrode bodies accommodated in the inside of one case 10 is not particularly limited, and may be one or two or more (plurality). It should be noted that as shown in FIG. 2, a positive current collecting part 50 is placed on one side (the left side in FIG. 2) in the long side direction Y of each electrode body, and the negative current collecting part 60 is placed on the other side (the right side in FIG. 2) in the long side direction Y. The electrode bodies 20a, 20 b and 20c are connected in parallel. However, the electrode bodies 20a, 20 b and 20c may be connected in series. The electrode body group 20 is covered with an electrode body holder 29 including a resin sheet, and accommodated in the inside of the case 10 here.

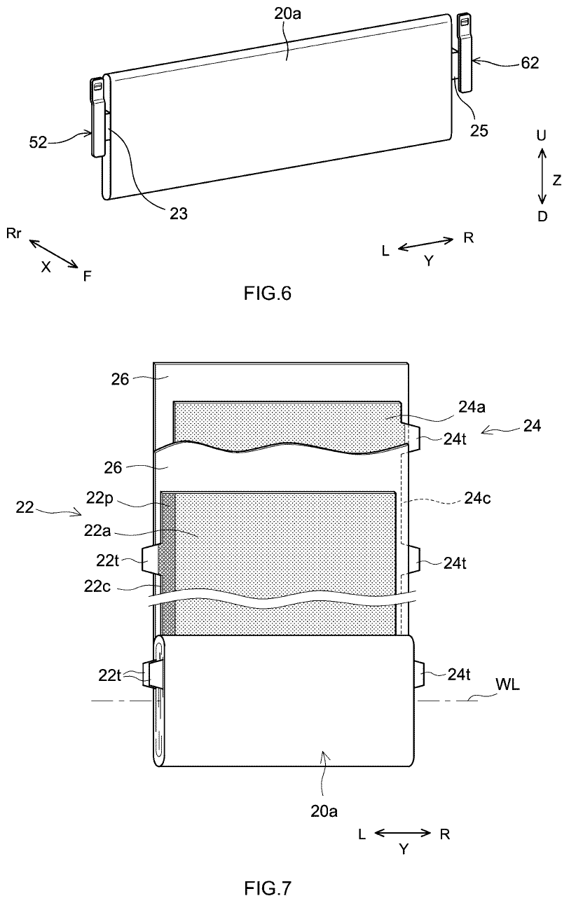

FIG. 6 is a perspective view schematically showing the electrode body 20a to which a second positive current collecting part 52 and a second negative current collecting part 62 are attached. FIG. 7 is a schematic diagram showing the structure of the electrode body 20a. It should be noted that the electrode body 20a will now be described in detail as an example, and the electrode bodies 20b and 20c can have the same structure.

As shown in FIG. 7, the electrode body 20a has a positive electrode 22, a negative electrode 24 and a separator 26. The electrode body 20a here is a wound electrode body, in which a strip-shaped positive electrode 22 and a strip-shaped negative electrode 24 are laminated via two strip-shaped separators 26, and they are wound onto the winding axis WL. However, the structure of the electrode body does not limit the technique disclosed herein. For example, the electrode body may be also a laminated electrode body in which quadrilateral (typically rectangular) positive electrodes and quadrilateral (typically rectangular) negative electrodes are laminated with the electrodes insulated.

The electrode body 20a has a flat shape in the present embodiment. The electrode body 20a is placed in the inside of the outer case 12 in a direction such that the winding axis WL is almost parallel to the long side direction Y. Specifically, as shown in FIG. 3, the electrode body 20a has a pair of curved parts (R parts) 20r facing the bottom wall 12a and the sealing plate 14 of the outer case 12, and a flat part 20f connecting a pair of the curved parts and facing the first side wall 12b of the outer case 12. The flat part 20f is extended along the first side wall 12b.

As shown in FIG. 7, the positive electrode 22 has a positive current collector 22c, and a positive active material layer 22a fixed onto at least one surface of the positive current collector 22c. The positive electrode 22 can have a positive electrode protection layer 22p. The positive current collector 22c is strip-shaped here. The positive current collector 22c includes electrically conductive metal such as aluminum, an aluminum alloy, nickel or stainless steel. The positive current collector 22c is, for example, metal foil, and aluminum foil here.

Positive electrode tabs 22t are provided on one end of the positive current collector 22c in the long side direction Y (the left end in FIG. 7). The positive electrode tabs 22t are provided at intervals (intermittently) along the longitudinal direction of the strip-shaped positive electrode 22. The positive electrode tabs 22t project beyond the outside of the separator 26 towards one side in the axial direction of the winding axis WL (the left side in FIG. 7). It should be noted that the positive electrode tabs 22t may be provided on the other side in the axial direction of the winding axis WL (the right side in FIG. 7) or on both the sides in the axial direction of the winding axis WL. The positive electrode tab 22t is part of the positive current collector 22c and includes metal foil (aluminum foil). However, the positive electrode tab 22t may be also a member different from the positive current collector 22c. In at least part of the positive electrode tab 22t, the positive active material layer 22a and the positive electrode protection layer 22p are not formed, and a region in which the positive current collector 22c is exposed is formed.

As shown in FIG. 4, the positive electrode tabs 22t are laminated on one end in the axial direction of the winding axis WL (the left end in FIG. 4) to form a positive electrode tab group 23. Each of the positive electrode tabs 22t is connected in a folded state to the positive current collecting part 50. Therefore, the size of the main body of the electrode body group 20 accommodated in the case 10 can be increased, and thus the high-energy density of the battery 100 can be achieved. As shown in FIG. 2, the positive electrode tab group 23 is electrically connected to the positive current collecting part 50. The positive electrode tab group 23 and a second positive current collecting part 52 described below are connected in a connecting part J here (see FIG. 4). The size of the positive electrode tabs 22t (the length in the long side direction Y and the width perpendicular to the long side direction Y, see FIG. 7) can be properly adjusted depending on, for example, the places thereof formed considering the state in which the tabs are connected to the positive current collecting part 50. The sizes of the positive electrode tabs 22t are different from each other so that the ends of the outer sides will be equal when being curved. It should be noted that the sizes of the positive electrode tabs may be also the same. The positive electrode tab 22t has a trapezoidal shape, but may also have other shapes (e.g., rectangular shape).

As shown in FIG. 7, the positive active material layer 22a is provided in a strip shape along the longitudinal direction of the strip-shaped positive current collector 22c. The positive active material layer 22a includes a positive active material (e.g., lithium transition metal composite oxide such as lithium nickel cobalt manganese composite oxide) which can reversibly absorb and release a charge carrier. When the total solid content of the positive active material layer 22a is 100 mass %, the positive active material may account for generally 80 mass % or more, typically 90 mass % or more, for example 95 mass % or more. The positive active material layer 22a may include optional components other than the positive active material, such as an electrically conducting material, a binder and various additive components. As the electrically conducting material, for example, a carbon material such as acetylene black (AB) can be used. As the binder, for example, polyvinylidene difluoride (PVdF) can be used.

As shown in FIG. 7, the positive electrode protection layer 22p is provided in the boundary between the positive current collector 22c and the positive active material layer 22a in the long side direction Y. The positive electrode protection layer 22p is provided on one end of the positive current collector 22c (the left end in FIG. 7) in the axial direction of the winding axis WL here. However, the positive electrode protection layer 22p may be provided on both the ends in the axial direction. The positive electrode protection layer 22p is provided in a strip shape along the positive active material layer 22a. The positive electrode protection layer 22p include an inorganic filler (e.g., alumina). When the total solid content of the positive electrode protection layer 22p is 100 mass %, the inorganic filler may account for generally 50 mass % or more, typically 70 mass % or more, and for example 80 mass % or more. The positive electrode protection layer 22p may include optional components other than the inorganic filler, such as an electrically conducting material, a binder and various additive components. The electrically conducting material and the binder may be the same as those shown as examples which can be included in the positive active material layer 22a.

As shown in FIG. 7, the negative electrode 24 has a negative current collector 24c, and a negative active material layer 24a fixed onto at least one surface of the negative current collector 24c. The negative current collector 24c is strip-shaped. The negative current collector 24c includes electrically conductive metal such as copper, a copper alloy, nickel or stainless steel. The negative current collector 24c is, for example, metal foil, and copper foil here.

Negative electrode tabs 24t are provided on one end of the negative current collector 24c (the right end in FIG. 7) in the axial direction of the winding axis WL. The negative electrode tabs 24t are provided at intervals (intermittingly) along the longitudinal direction of the strip-shaped negative electrode 24. Each of the negative electrode tabs 24t projects beyond the outside of the separator 26 towards one side in the axial direction (the right side in FIG. 7). However, the negative electrode tab 24t may be provided on the other side in the axial direction (the left end in FIG. 7) or on both the sides in the axial direction. The negative electrode tab 24t is part of the negative current collector 24c and includes metal foil (copper foil). However, the negative electrode tab 24t may be also a member different from the negative current collector 24c. In at least part of the negative electrode tab 24t, the negative active material layer 24a is not formed, and a region in which the negative current collector 24c is exposed is formed.

As shown in FIG. 4, the negative electrode tabs 24t are laminated on one end in the axial direction (the right end in FIG. 4) to form a negative electrode tab group 25. The negative electrode tab group 25 is preferably provided at a place symmetric about the positive electrode tab group 23 in the axial direction. Each of the negative electrode tabs 24t is connected in a folded state to the negative current collecting part 60. Therefore, the size of the main body of the electrode body group 20 accommodated in the case 10 can be increased, and thus the high-energy density of the battery 100 can be achieved. As shown in FIG. 2, the negative electrode tab group 25 is electrically connected to the negative current collecting part 60. The negative electrode tab group 25 and a second negative current collecting part 62 described below are connected in a connecting part J here (see FIG. 4). The sizes of the negative electrode tabs 24t are different from each other so that the ends of the outer sides will be equal when being curved here as in the case of the positive electrode tabs 22t. It should be noted that the technique disclosed herein can be applied also when the sizes of the negative electrode tabs are the same. The negative electrode tab 24t has a trapezoidal shape, but may also have other shapes (e.g., rectangular shape).

As shown in FIG. 7, the negative active material layer 24a is provided in a strip shape along the longitudinal direction of the strip-shaped negative current collector 24c. The negative active material layer 24a includes a negative active material (e.g., a carbon material such as graphite) which can reversibly absorb and release a charge carrier. When total solid content of the negative active material layer 24a is 100 mass %, the negative active material may account for generally 80 mass % or more, typically 90 mass % or more, and for example 95 mass % or more. The negative active material layer 24a may include optional components other than the negative active material, such as a binder, a dispersant and various additive components. As the binder, rubbers such as styrene butadiene rubber (SBR) can be used. As the dispersant, celluloses such as carboxymethylcellulose (CMC) can be used.

As shown in FIG. 7, the separator 26 is a member which insulates the positive active material layer 22a of the positive electrode 22 from the negative active material layer 24a of the negative electrode 24. The separator 26 is suitably a porous sheet made of a resin including a polyolefin resin such as polyethylene (PE) or polypropylene (PP). The separator 26 may have a base material part including a porous sheet made of a resin, and a heat resistant layer (HRL) provided on at least one surface of the base material part and including an inorganic filler. As the inorganic filler, for example, alumina, boehmite, aluminum hydroxide, titania and the like can be used.

The electrolyte solution may be the same as those which have been conventionally used, and is not particularly limited. The electrolyte solution is, for example, a non-aqueous electrolyte solution containing a non-aqueous solvent and a supporting salt. Examples of the non-aqueous solvent include carbonates such as ethylene carbonate, dimethyl carbonate and ethylmethyl carbonate. The supporting salt is, for example, a fluorine-containing lithium salt such as LiPF₆. However, the electrolyte solution may be in a solid form (solid electrolyte), which is integrated with the electrode body group 20.

The positive current collecting part 50 forms at least part of the conductive path from the positive electrode tab group 23 including the positive electrode tabs 22t to the outside of the case 10. In the present embodiment, as shown in FIG. 2, the positive current collecting part 50 includes the first positive current collecting part 51 and the second positive current collecting part 52. It should be noted that unlike the present embodiment, the positive current collecting part 50 need not be formed from members, and may be formed from one member.

In the present embodiment, as the first positive current collecting part 51, a first current collecting member 70 disclosed herein is adopted. The structure of the first current collecting member 70 will be described below.

The second positive current collecting part 52 is extended along the second side wall 12c of the outer case 12. In the present embodiment, the second positive current collecting part 52 is formed into a plate shape extended along the vertical direction Z as shown in FIG. 6. The second positive current collecting part 52 has an inclined part in the course of extension in the vertical direction Z. One end of the second positive current collecting part is joined to the first positive current collecting part 51, and the other end is joined to the positive electrode tab group 23. These joints can be each realized by welding such as ultrasonic welding, electric resistance welding or laser welding. The second positive current collecting part 52, for example, can be formed from the same metal species as of the positive current collector 22c, and can be formed from electrically conductive metal such as aluminum, an aluminum alloy, nickel or stainless steel.

As shown in FIG. 1 and FIG. 2, the positive terminal member 30 is placed so that at least a part thereof will be exposed to the outside of the case 10. When the positive terminal member 30 is electrically connected to the positive current collecting part 50, the conductive path is extended, and connectivity with an external member (e.g., bus-bar) can be improved. In the present embodiment, as shown in FIG. 2, the positive terminal member 30 is electrically connected to the first positive current collecting part 51 in the inside of the first through hole 18 provided in the sealing plate 14. The upper surface 30a of the positive terminal member 30 is placed to the outside of the case 10, and can be a joint surface with an external member. The positive terminal member 30 is preferably made of metal, and can be formed from, for example, aluminum, an aluminum alloy, nickel or stainless steel.

The negative current collecting part 60 forms at least part of the conductive path from the negative electrode tab group 25 including the negative electrode tabs 24t to the outside of the case 10. In the present embodiment, as shown in FIG. 2, the negative current collecting part 60 includes the first negative current collecting part 61 and the second negative current collecting part 62. It should be noted that unlike the present embodiment, the negative current collecting part 60 need not be formed from members, and may be formed from one member. In the present embodiment, as the first negative current collecting part 61, the first current collecting member 70 disclosed herein is adopted.

The second negative current collecting part 62 is extended along the second side wall 12c of the outer case 12. In the present embodiment, the second negative current collecting part 62 is formed into a plate shape extended along the vertical direction Z as shown in FIG. 6. The second negative current collecting part 62 has an inclined part in the course of extension in the vertical direction Z. One end of the second negative current collecting part 62 is joined to the first negative current collecting part 61, and the other end is joined to the negative electrode tab group 25. These joints can be each realized by welding such as ultrasonic welding, electric resistance welding or laser welding. The second negative current collecting part 62, for example, can be formed from the same metal species as of the negative current collector 24c, and can be formed from electrically conductive metal such as copper, a copper alloy, nickel or stainless steel.

As shown in FIG. 1 and FIG. 2, the negative terminal member 40 is placed so that at least a part thereof will be exposed to the outside of the case 10. When the negative terminal member 40 is electrically connected to the negative current collecting part 60, the conductive path is extended, and connectivity with an external member (e.g., bus-bar) can be improved. In the present embodiment, as shown in FIG. 2, the negative terminal member 40 is electrically connected to the first negative current collecting part 61 in the inside of the second through hole 19 provided in the sealing plate 14. The negative terminal member 40 is preferably made of metal, and more preferably includes, for example, copper or a copper alloy.

The first current collecting member 70 disclosed herein will now be described. The first current collecting member 70 is a member which is electrically connected to at least one electrode of the first electrode and the second electrode. In the description below, it will be described in detail using as an example an embodiment in which the first current collecting member 70 is electrically connected to the positive electrode as the first electrode. It should be noted that the first current collecting member 70 can be also adopted for the negative electrode, and the structure thereof, for example, is understood by reading the positive electrode as the negative electrode in the description below.

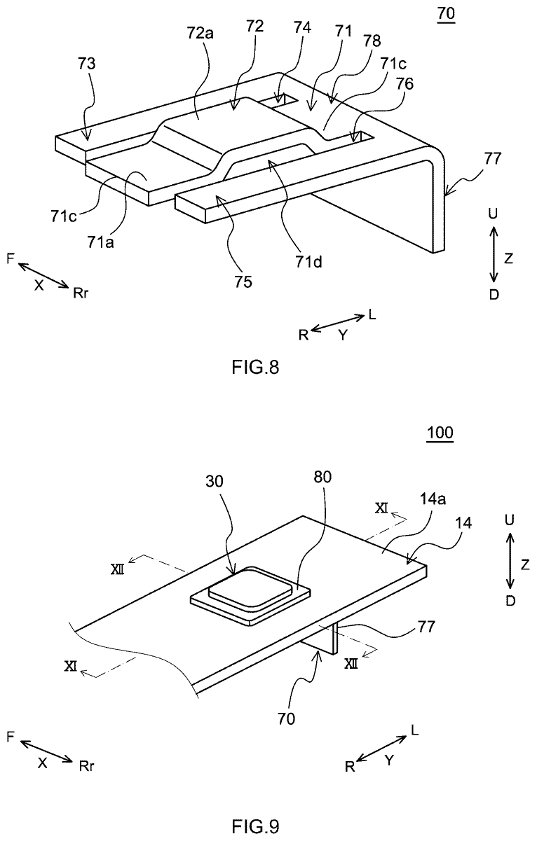

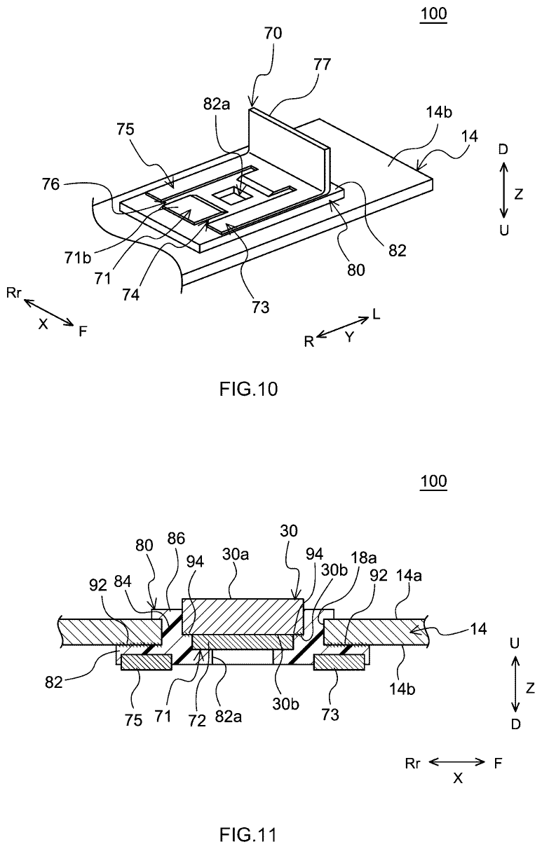

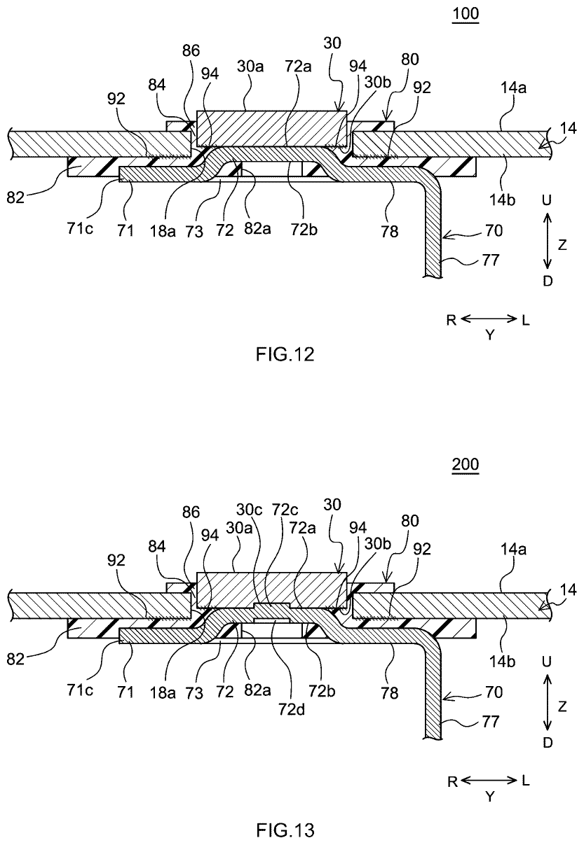

FIG. 8 is a perspective view schematically showing one embodiment of the structure of the first current collecting member disclosed herein. FIG. 9 is a perspective view schematically showing a structure in the vicinity of the first through hole in the vicinity of the sealing plate to which the first current collecting member is attached. FIG. 10 is a perspective view of the structure in the vicinity of the first through hole of the sealing plate to which the first current collecting member shown in FIG. 9 is attached when viewed from the inner surface side of the sealing plate. FIG. 11 is a cross-sectional view taken along the line XI-XI in FIG. 9. FIG. 12 is a cross-sectional view taken along the line XII-XII in FIG. 9.

As shown in FIG. 8, the first current collecting member 70 has a first region 71, a second region 73, and a first slit 74 formed between the first region 71 and the second region 73. In the present embodiment, it further has a third region 75, a second slit 76 formed between the first region 71 and the third region 75, a fourth region 77 and a fifth region 78.

The first region 71 is a region placed along the inner surface 14b on the first wall (the sealing plate 14 here) of the case 10. The upper surface 71a of the first current collecting member 70 in the first region 71 faces the inner surface 14b of the sealing plate 14. The first region 71 is extended towards the longitudinal direction (long side direction Y) of the sealing plate 14 here. In the first region 71, a base part 71c and a projection part 72 projecting from the base part 71c are provided. The projection part 72 projects to the first wall (sealing plate 14). In the present embodiment, the projection part 72 has an upper surface 72a (top surface). The projection part 72 has a lower surface 72b opposite to the upper surface 72a. It should be noted that the head part of the projection part 72 need not have the upper surface. In the present embodiment, base parts 71c are placed on both sides of the projection part 72 in the long side direction Y.

In the first region 71, the first current collecting member 70 is formed into a plate shape in the present embodiment. The projection part 72 is formed so that the plate-shaped first current collecting member 70 will be folded to project to the upper surface 71a side. Therefore, a concave part 71d corresponding to the shape of the projection part 72 is provided on the lower surface 71b of the first current collecting member 70 in the first region 71. The bottom surface of such concave part 71d is the lower surface 72b of the projection part 72. Because the plate-shaped first current collecting member 70 is folded to form the projection part 72 here, the average thickness of the first current collecting member 70 on the upper surface 72a of the projection part 72 and the average thickness of the first current collecting member 70 in the base part 71c are almost the same. When the average thickness of the first current collecting member 70 in the base part 71c is 100%, for example, the average thickness of the first current collecting member 70 on the upper surface 72a of the projection part 72 can be 90% to 100% or 95% to 105%. As described above, it is preferred that the projection part 72 be formed by folding a plate-shaped member because the projection part 72 is lighter than a structure in which the projection part 72 is a solid axis, and the battery 100 can be lighter. However, the structure of the projection part 72 is not limited thereto, and may be formed from a solid axis or a hollow axis. It should be noted that the average thickness of the first current collecting member 70 can be measured, for example, by a reflective laser displacement sensor.

It is preferred that the length of the first region 71 in the longitudinal direction (direction Y) of the sealing plate 14 be greater than the longest length of the first through hole 18 in the longitudinal direction. Therefore, an insulating member 80 described below, placed between the first region 71 and the sealing plate 14 can be placed on both sides of the longitudinal direction of the first through hole 18, and thus the sealing properties in the vicinity of the first through hole 18 can be improved.

The second region 73 is a region placed along the inner surface 14b of the first wall (sealing plate 14 here) of the case 10 as in the case of the first region 71. The second region 73 is a region placed on the transverse side of the first region 71. In other words, the second region 73 is placed at a place shifted from the first region 71 (e.g. a place shifted from the base part 71c) on the surface parallel to the inner surface 14b of the first wall (sealing plate 14). The second region 73 is placed on one side of the first region 71 in the short side direction X of the battery 100 here. It should be noted that the second region 73 may be placed on one side of the first region 71 in the long side direction Y of the battery 100. The second region 73 is extended towards the longitudinal direction (long side direction Y) of the first wall (sealing plate 14) here. In the present embodiment, the first current collecting member 70 in the second region 73 is formed into a plate shape.

The first slit 74 is formed between the first region 71 and the second region 73. In the present embodiment, the first slit 74 is formed into an almost rectangular shape in a planar view. In a planar view, it has an almost rectangular shape in which the distance between the first region 71 and the second region 73 is the short side and the direction perpendicular to the short side is the long side here. Because the first current collecting member 70 has the first slit 74, an insulating member 80 described below easily enters the first slit 74, and the sealing properties in the periphery of the first through hole 18 can be improved.

In the present embodiment, the length of the first slit 74 in the longitudinal direction (direction Y) of the sealing plate 14 is greater than the longest length in the longitudinal direction of the first through hole 18. Furthermore, the first slit 74 is placed to span both ends of the first through hole 18 in the longitudinal direction. Because of this, the sealing properties in the periphery of the first through hole 18 can be improved.

The third region 75 is a region placed along the inner surface 14b of the first wall (sealing plate 14 here) of the case 10. The third region 75 is a region placed on the transverse side of the first region 71. The third region 75 is placed on the opposite side of the second region 73 with respect to the first region 71 here. That is, the first region 71 is placed between the second region 73 and the third region 75. The third region 75 is placed on one side of the first region 71 in the short side direction X of the battery 100 here. It should be noted that the third region 75 may be placed on one side of the first region 71 in the long side direction Y of the battery 100. The third region 75 is extended towards the longitudinal direction (long side direction Y) of the first wall (sealing plate 14) here. In the present embodiment, the first current collecting member 70 in the third region 75 is formed into a plate shape. It should be noted that the third region 75 is not an essential structure.

The second slit 76 is formed between the first region 71 and the third region 75. In the present embodiment, the second slit 76 is formed into a rectangular shape in a planar view. It has a rectangular shape in which the distance between the first region 71 and the third region 75 is the short side and the direction perpendicular to the short side is the long side in a planar view here. Because the first current collecting member 70 has the second slit 76, an insulating member 80 described below easily enters the second slit 76, and the sealing properties in the periphery of the first through hole 18 can be improved. Because the first current collecting member 70 has the first slit 74 and the second slit 76, the sealing properties are improved on both sides of the first through hole 18, and thus a battery 100 having higher sealing reliability can be achieved. It should be noted that the second slit 76 is not an essential structure.

In the present embodiment, the length of the second slit 76 in the longitudinal direction (direction Y) of the sealing plate 14 is greater than the longest length of the first through hole 18 in the long side direction. Furthermore, the second slit 76 is placed to span both sides of the first through hole 18 in the long side direction. Because of this, the sealing properties in the periphery of the first through hole 18 can be further improved.

As shown in FIG. 8, in the present embodiment, the fourth region 77 is a region extended in the vertical direction Z. The fourth region 77 is a region extended from the sealing plate 14 side to the bottom wall 12a side of the case 10. The fourth region 77 is placed, for example, along the first side wall 12b or the second side wall 12c of the case 10. In the present embodiment, the fourth region 77 is placed along the second side wall 12c. The fourth region 77 is electrically connected to the second positive current collecting part 52 here. Because of this, conduction to the first current collecting member 70 is realized. It should be noted that the fourth region 77 may be directly joined to the positive electrode tab group 23. Therefore, the number of parts for the conductive path can be reduced, and costs can be reduced. Such joints can be realized by welding such as ultrasonic welding, electric resistance welding or laser welding. It should be noted that in the present embodiment, the first current collecting member 70 in the fourth region 77 is formed into a plate shape. It should be noted that the fourth region 77 is not an essential structure in this technique.

The fifth region 78 is a region which links the first region 71 and the fourth region 77. As shown in FIG. 8, the fifth region 78 is placed between the first region 71 and the fourth region 77 here. The fifth region 78 is placed to be continuous with the first region 71. The fifth region 78 is placed to be continuous with the fourth region 77 here. In the present embodiment, the fifth region 78 is also located between the second region 73 and the fourth region 77, and is placed to be continuous with the second region 73. The fifth region 78 is also located between the third region 75 and the fourth region 77, and is placed to be continuous with the third region 75. The fifth region 78 is placed along the inner surface 14b of the first wall (sealing plate 14 here) of the case 10. The first current collecting member 70 is formed into a plate shape in the fifth region 78 here. It should be noted that the fifth region 78 is not an essential structure in this technique. For example, the fourth region 77 and the first region 71 may be linked together. The second region 73 and/or the third region 75 may be also linked to the fourth region 77.

The first current collecting member 70 can be made of metal, for example. Examples of the metal include aluminum, an aluminum alloy, copper, a copper alloy and the like.

The whole thickness of the first current collecting member 70 is preferably approximately constant. When the average thickness of the first current collecting member 70 is 100%, for example, the maximum thickness of the first current collecting member 70 is preferably 120% or less, more preferably 110% or less and further preferably 105% or less. The minimum thickness of the first current collecting member 70 is preferably 80% or more, more preferably 90% or more and further preferably 95% or more.

The first current collecting member 70 can be easily produced, for example, by bending or punching of a plate-shaped material (e.g. metal plate). Because of this, the first current collecting member 70 in which the whole thickness is almost constant can be realized.

At least part of the projection part 72 in the first current collecting member 70 is placed in the inside of the first through hole 18 provided in the sealing plate 14 (see FIG. 11 and FIG. 12). The upper surface 72a, which is the upper end (top) of the projection part 72, is placed in the inside of the first through hole 18 here. In the present embodiment, the upper surface 72a of the projection part 72 is connected to the lower surface 30b of the positive terminal member 30 in the inside of the first through hole 18. The method for connecting the positive terminal member 30 and the first current collecting member 70 is not particularly limited, and examples thereof include caulking, ultrasonic welding, electric resistance welding, laser welding, pressure welding and the like. One of these can be selected or two or more of these can be used in combination. It should be noted that the positive terminal member 30 is not an essential structure in this technique. In the present embodiment, the lower surface 72b of the projection part 72 is placed not in the inside of the first through hole 18 but in the inner side of the case 10. However, the lower surface 72b of the projection part 72 may be also placed in the inside of the first through hole 18.

As shown in FIGS. 9 to 12, the insulating member 80 insulates the first current collecting member 70 from the case 10 (sealing plate 14 here). Here, the insulating member 80 insulates the positive terminal member 30 from the case 10 (sealing plate 14 here). In the present embodiment, the insulating member 80 includes a first insulating part 82 placed in the inside of the case 10, a second insulating part 84 placed in the inside of the first through hole 18, and a third insulating part 86 placed on the outside of the case 10.

As shown in FIGS. 10 to 12, the first insulating part 82 is placed along the inner surface 14b of the sealing plate 14. The first insulating part 82 is placed between the regions of the first current collecting member 70 facing the sealing plate 14 and the inner surface 14b of the sealing plate 14, in the inside of the case 10. The second region 73 of the first current collecting member 70 is placed to face the inner surface 14b of the sealing plate 14 with the first insulating part 82 therebetween here. In the present embodiment, the third region 75 and the fifth region 78 of the first current collecting member 70 are each also placed to face the inner surface 14b of the sealing plate 14 with the first insulating part 82 therebetween. Part of the first region 71 in the first current collecting member 70 placed in the inside of the case 10 is placed to face the inner surface 14b of the sealing plate 14 with the first insulating part 82 therebetween.

The first insulating part 82 is preferably placed without gaps between the regions of the first current collecting member 70 facing the sealing plate 14 and the inner surface 14b of the sealing plate 14. Because of this, the sealing properties in the periphery of the first through hole 18 can be further improved.

At least part of the first insulating part 82 is preferably placed in the inside of the first slit 74 in the first current collecting member 70 (see FIG. 10). Therefore, the first current collecting member 70 and the first insulating part 82 adhere more closely to each other, and thus the sealing properties in the vicinity of the first through hole 18 can be improved. In the present embodiment, the first insulating part 82 is placed on the sealing plate 14 side in the inside of the first slit 74, and the first insulating part 82 is not placed on the end of the electrode body group 20 side in the inside of the first slit 74. Such structure is advantageous from the viewpoint of weight saving of the battery 100. However, the first insulating part 82 may be placed in the entire inside of the first slit 74. Such structure is advantageous from the viewpoint of improvements in the sealing properties.

At least part of the first insulating part 82 is preferably placed in the inside of the second slit 76 in the first current collecting member 70 (see FIG. 10). Therefore, the first current collecting member 70 and the first insulating part 82 adhere more closely to each other, and thus the sealing properties in the vicinity of the first through hole 18 can be improved. In the present embodiment, the first insulating part 82 is placed on the sealing plate 14 side in the inside of the second slit 76, and the first insulating part 82 is not placed on the end of the electrode body group 20 side in the inside of the second slit 76. Such structure is advantageous from the viewpoint of weight saving of the battery 100. However, the first insulating part 82 may be placed in the entire inside of the second slit 76. Such structure is advantageous from the viewpoint of improvements in the sealing properties.

At least part of the first insulating part 82 is preferably placed on the electrode body group 20 side of the projection part 72 (the lower surface 72b side of the projection part 72) in the first current collecting member 70. The projection part 72 and the first insulating part 82 are placed to abut against each other. Therefore, the sealing properties in the vicinity of the first through hole 18 can be improved. The first insulating part 82 is preferably bridged to pass through the electrode body group 20 side of the projection part 72. In the present embodiment, the first insulating part 82 is bridged on the electrode body group 20 side (concave part 71d) of the projection part 72 at two points in the lateral direction of the sealing plate 14. Therefore, the first current collecting member 70 and the insulating member 80 adhere more closely to each other, and thus the sealing properties can be improved. It should be noted that the number of bridges is not particularly limited, and one or two or more bridges may be used.

It is preferred that the first insulating part 82 placed on the electrode body group 20 side of the projection part 72 be not placed on the lower surface 71b side of the base part 71c in the first region 71. In other words, it is preferred that the lower surface 71b of the base part 71c be exposed. Because of this, the space occupied by the electrode body group 20 can be expanded in the inside of the case 10. On the lower surface 71b of the first region 71, the first insulating part 82 is placed only in the concave part 71d on the electrode body group 20 side of the projection part 72 here.

The first insulating part 82 may have a through hole 82a penetrating from the electrode body group 20 side towards the lower surface of the projection part 72 in a position on the electrode body group 20 side of the projection part 72. As shown in FIG. 10, the lower surface 72b of the projection part 72 is exposed in such through hole 82a when viewed from the inner surface 14 side of the sealing plate 14. Such through hole 82a can be formed, for example, by a production step described below.

It is preferred that the first insulating part 82 be not placed on the surface of the electrode body group 20 side (lower surface) of the first current collecting member 70 in the second region 73 and the lower surface be exposed. It is preferred that the first insulating part 82 be not placed on the surface on the electrode body group 20 side (lower surface) of the first current collecting member 70 in the third region 75 and the lower surface be exposed. Because of this, the space occupied by the electrode body group 20 can be expanded in the inside of the case 10.

The first insulating part 82 is preferably placed to span the periphery of the first through hole 18. Because of this, the sealing properties in the vicinity of the first through hole 18 can be improved. The first insulating part 82 is preferably placed to span the surroundings of the regions of the first current collecting member 70 facing the sealing plate 14. In the present embodiment, the first insulating part 82 is placed to extend beyond the first region 71, the second region 73 and the third region 75 in the longitudinal direction (direction Y) of the sealing plate 14, and to extend beyond the fourth region 77. The first insulating part 82 is placed to extend beyond the second region 73 and to extend beyond the third region 75 in the lateral direction (direction X) of the sealing plate 14. As shown in FIG. 11 and FIG. 12, the thickness of the first insulating part 82 in the surroundings of the regions of the first current collecting member 70 facing the sealing plate 14 may be greater than the thickness of the first insulating part 82 placed between the first current collecting member 70 and the sealing plate 14. The first insulating part 82 can be placed to be in contact with not only the surface of the first current collecting member 70 facing the sealing plate 14 in the inside of the case 10 but also the side surface of the first current collecting member 70 extending in the thickness direction of the first current collecting member 70. Therefore, the adhesion between the first current collecting member 70 and the first insulating part 82 is improved and the sealing properties can be improved.

It should be noted that as shown in FIG. 2, the first insulating part 82 may include a movement restricting part 82b to restrict the movement of the electrode body group 20 to the sealing plate 14 side. In FIG. 2, as the movement restricting part 82b, the end of the first insulating part 82 projects to the electrode body group 20 side.

The second insulating part 84 is placed between the inside surface 18a of the first through hole 18 and the first current collecting member 70 placed in the inside of the first through hole 18, and insulates the first current collecting member 70 from the sealing plate 14. The second insulating part 84 is also placed between the inside surface 18a of the first through hole 18 and the positive terminal member 30 placed in the inside of the first through hole 18, and insulates the positive terminal member 30 from the sealing plate 14 here.

The second insulating part 84 is preferably placed to close the first through hole 18. As shown in FIG. 11 and FIG. 12, in the present embodiment, the first through hole 18 is closed by the second insulating part 84 and the upper end of the projection part 72. Because of this, the sealing properties are improved. It should be noted that when at least part of the concave part 71d of the first region 71 in the first current collecting member 70 is placed in the first through hole 18, the second insulating part 84 may be also placed in such concave part 71d.

The third insulating part 86 is a part continuous with the second insulating part 84, and is placed in the outside of the case 10. The third insulating part 86 is placed along the surroundings of the positive terminal member 30 in the outside of the case 10 here. The third insulating part 86 is preferably in contact with the surrounding region of the first through hole 18 on the outer surface 14a of the sealing plate 14 (first wall). In a planar view, the periphery of the third insulating part 86 is placed in the outside of the first through hole 18, and the periphery is in contact with the outer surface 14a of the sealing plate 14 here. Because of this, the sealing properties in the vicinity of the first through hole 18 can be improved. It should be noted that the insulating member 80 need not include the third insulating part 86.

The insulating member 80 is formed, for example, from a resin having electric insulation properties. Examples of such resin include polyolefin resins such as polypropylene (PP), fluororesins such as perfluoroalkoxyethylene copolymer (PFA) and polytetrafluoroethylene (PTFE), polyphenylenesulfide (PPS) and the like.

The insulating member 80 can be formed from members, but is preferably an integral product (single-piece product) including one member. When the insulating member 80 is an integral product, the airtightness between the first insulating part 82 and the second insulating part 84 is improved. In the present embodiment, the insulating member 80 is an integral product continuously including the first insulating part 82, the second insulating part 84 and the third insulating part 86, and the sealing properties in the vicinity of the first through hole 18 are improved. That is, the insulating member 80 is placed between the first region 71 and the sealing plate 14, further passes through the first through hole 18, and is in contact with the surrounding region of the first through hole 18 on the outer surface 14a of the sealing plate 14.

In this technique, the insulating member 80, the sealing plate 14 and the first current collecting member 70 are preferably a single-piece product. In other words, the sealing plate 14 and the first current collecting member 70 are molded with the insulating member 80. By this, the insulating member 80 adheres closely to the sealing plate 14 and the first current collecting member 70, and thus airtightness of the first through hole 18 included in the sealing plate 14 and the surroundings thereof is improved. It should be noted that in the present embodiment, in addition to the sealing plate 14 and the first current collecting member 70, the positive terminal member 30 is also molded with the insulating member 80, and the insulating member 80, the sealing plate 14, the first current collecting member 70 and the positive terminal member 30 are a single-piece product.

It should be noted that the insulating member 80 can be also used for the negative electrode side in the same manner. This case is understood by properly changing the positive electrode to the negative electrode in the above-described description.

As shown in FIG. 11 and FIG. 12, a first surface-treated part 92 can be provided in the vicinity of the periphery of the first through hole 18 on the inner surface 14b of the sealing plate 14 (first wall). The first surface-treated part 92 is in contact with the insulating member 80. Airtightness and joint strength between the inner surface 14b of the sealing plate 14 and the insulating member 80 can be improved in the vicinity of the first through hole 18 by providing the first surface-treated part 92, and thus the sealing properties in the vicinity of the first through hole 18 can be improved. The first surface-treated part 92 may be provided in at least a part in the vicinity of the periphery of the first through hole 18, but is preferably provided in the entire periphery thereof to surround the first through hole 18.

The first surface-treated part 92 is preferably processed to increase surface roughness (that is, a rough surface part). The arithmetic mean roughness (Ra) of the first surface-treated part 92 is preferably, for example, two times or more, or may be three times or more or four times or more greater than the arithmetic mean roughness of a part on the inner surface 14b of the sealing plate 14 (first wall), except for the first surface-treated part 92 (a part which is not surface-roughened). It should be noted that the upper limit thereof is not particularly limited, and can be for example ten times or less. As the arithmetic mean roughness increases, adhesion between the first surface-treated part 92 and the insulating member 80 is improved by the anchor effect. It should be noted that the arithmetic mean roughness in this technique is measured based on JIS B0601:2001 using a contact stylus surface roughness tester. As the method for surface treatment of the first surface-treated part 92, a known method can be applied, and examples thereof include methods such as chemical etching, laser processing and blasting.

The first surface-treated part 92 may be treated to form a chemical bond with a resin. As the method for surface treatment, a known method can be applied, and examples thereof include methods such as silane coupling treatment.

As shown in FIG. 11 and FIG. 12, in the present embodiment, the area of the lower surface 30b of the positive terminal member 30 is greater than the area of the upper surface 72a of the projection part 72 in the first current collecting member 70. Because of this, the contact surface between the lower surface 30b of the positive terminal member 30 and the insulating member 80 is increased, and the strength of the positive terminal member 30 can be improved. In this case, a second surface-treated part 94 can be provided on the lower surface 30b of the positive terminal member 30. The second surface-treated part 94 is in contact with the insulating member 80. In the second surface-treated part 94, adhesion with the insulating member 80 is improved, and airtightness and adhesive strength can be improved.

The second surface-treated part 94 is preferably processed to increase surface roughness (that is, a rough surface part). The arithmetic mean roughness (Ra) of the second surface-treated part 94 is preferably, for example, two times or more, or may be three times or more or four times or more greater than the arithmetic mean roughness of part of the positive terminal member 30 which is not surface-treated (e.g. the upper surface or the side surface of the positive terminal member 30). It should be noted that the upper limit thereof is not particularly limited, and can be for example ten times or less. As the arithmetic mean roughness increases, adhesion between the second surface-treated part 94 and the insulating member 80 is improved by the anchor effect. It should be noted that as the method for surface treatment of the second surface-treated part 94, a known method can be applied, and examples thereof include methods such as chemical etching, laser processing and blasting.

The second surface-treated part 94 may be treated to form a chemical bond with a resin. As the method for surface treatment, a known method can be applied, and examples thereof include methods such as silane coupling treatment.

The battery 100 as described above can be produced, for example, by a production method, including a preparation step and a sealing step. The preparation step encompasses an integration molding step. It should be noted that the method for producing the battery 100 is not limited to the production method described herein.

In the preparation step, the outer case 12, the sealing plate 14, the first current collecting member 70 and the electrode body 20a are prepared. The electrode body 20a may be the electrode body group 20. The positive terminal member 30, the negative terminal member 40, the second positive current collecting part 52 and the second negative current collecting part 62 may be further prepared as needed here.

In the integration molding step, the sealing plate 14, the first current collecting member 70 and the insulating member 80 are integrally molded. In the above-described battery 100, the positive terminal member 30 is also integrally molded. The method for integration molding can be performed, for example, in accordance with a conventionally known method as described in Japanese Unexamined Patent Application Publication No. 2021-086813. The integration molding step can be performed, for example, using molds by a method including a part setting step, an upper mold setting step, an injection molding step and a part stripping step.

In the part setting step, molds which can achieve a desired structure of the insulating member 80 are prepared. The molds include, for example, the upper mold and the lower mold. The upper mold has a gate part to inject melt resin which forms the insulating member 80. First, the first current collecting member 70 and the sealing plate 14 are placed in the lower mold. Part of the first current collecting member 70 in which the insulating member 80 is not placed is preferably in contact with the lower mold. For example, the lower surface 71b of the first region 71 (base part 71c) and the lower surface of the second region 73 may be placed without gaps on the lower mold. The lower mold preferably has a supporting part which is in contact with and supports the lower surface 72b of the projection part 72 in the first current collecting member 70. By supporting the projection part 72 using the supporting part, pressure is applied from the upper surface 72a side of the projection part 72, and the lower surface of the first current collecting member 70 can be allowed to adhere closely to the lower mold. This can prevent melt resin for the insulating member 80 from entering the lower surface of the first current collecting member 70. It should be noted that the through hole 82a of the first insulating part 82 in the insulating member 80 can be a mark left when the supporting part has been placed. The sealing plate 14 is positioned to place at least part of the projection part 72 in the first current collecting member 70 in the inside of the first through hole 18.

In the upper mold setting step, the first current collecting member 70 and the sealing plate 14 are placed, and then the upper mold is placed on the outer surface 14a side of the sealing plate 14. At this time, the upper mold is preferably in contact with the outer surface 14a of the sealing plate 14 in the periphery of the third insulating part 86 formed so that melt resin will not flow to the outer surface 14a of the sealing plate 14. The upper mold is preferably in contact with the upper surface 72a of the projection part 72. This can prevent the insulating member from being placed on the upper surface 72a of the projection part 72. Both surfaces of the upper surface 72a of the projection part 72 can be put between the supporting part of the lower mold and the upper mold, and thus pressure can be stably applied to the projection part 72.

In the injection molding step, melt resin obtained by melting a resin to form the insulating member 80 is injected from the gate part of the upper mold. The melt resin is injected into the inside of the upper mold, further passes through the first through hole 18, and filled in the inside of the lower mold. The mold is preferably heated in advance before being filled with the melt resin. The heating temperature is not limited, and can be for example 100° C. to 200° C.

In the part stripping step, first, the filled melt resin is cooled. Therefore, the melt resin is solidified to produce the insulating member 80. Then, the upper mold is separated from the lower mold, and a single-piece product obtained by molding the sealing plate 14 and the first current collecting member 70 with the insulating member 80 is taken out. Then, the gate part and molding flash may be removed as needed.

It should be noted that when the battery 100 includes the positive terminal member 30, it is only required to connect the first current collecting member 70 and the positive terminal member 30 in advance and to place the members in the lower mold in the part setting step. Therefore, the positive terminal member 30, the first current collecting member 70, the sealing plate 14 and the insulating member 80 can be integrally molded. The description of the above-described integration molding step is about the surroundings of the first through hole 18; however, the same step can be performed for the second through hole 19.

In the sealing step, first, the prepared single-piece product and the electrode body 20a are connected. At this time, the integrally molded first current collecting member 70 and the electrode tab of the electrode body 20a are directly connected. Alternatively, the first current collecting member 70 and the electrode body 20a may be connected via the second positive current collecting part 52 or the second negative current collecting part 62. Next, the electrode body 20a is inserted from the opening 12h of the outer case 12, and the integrally molded sealing plate 14 and the periphery of the opening 12h of the outer case 12 are joined by laser welding or the like. It should be noted that an electrode body holder 29 may be between the outer case 12 and the electrode body 20a. Next, the electrolyte solution is injected from the injection hole 15, and the injection hole 15 is closed with the sealing member to tightly cover the case 10. As described above, the battery 100 can be produced.

The battery 100 can be employed for various uses, and can be suitably used, for example, as power sources for motors (driving power supply) mounted on vehicles such as cars and trucks. The kind of vehicle is not particularly limited, and examples thereof include plug-in hybrid vehicles (PHEV), hybrid electric vehicles (HEV), battery electric vehicles (BEV) and the like. The battery 100 can be also suitably used as a single cell forming an assembled battery.

As described above, some embodiments of this technique have been described; however, the embodiments are only examples. This technique can be implemented in other various forms. Various variants and modifications of the embodiments shown above as examples are encompassed in the technique described in claims. For example, part of the embodiments can be also replaced with another embodiment, and another embodiment can be also added to the embodiments. When technical features are not described as essential, they can be properly removed.

In the embodiments, for example, the upper surface 72a of the projection part 72 in the first current collecting member 70 was placed in the inside of the first through hole 18. However, the upper surface 72a of the projection part 72 may be placed in the outside of the case 10. In this embodiment, the positive terminal member 30 need not be included. For example, an external member (e.g. bus-bar) can be easily directly connected to the upper surface 72a of the projection part 72 placed in the outside of the case 10 without the positive terminal member. Therefore, the number of members for forming the conductive path can be reduced, which can result in cost saving.

FIG. 13 is a corresponding diagram of FIG. 12 on the battery 200 according to another embodiment. A concave part 30c is provided on the lower surface 30b of the positive terminal member 30 here. A convex part 72c is provided on the upper surface 72a of the projection part 72 in the first current collecting member 70. A concave part 72d is provided on the lower surface 72b of the projection part 72. The concave part 72d is located on the back side of the convex part 72c and can be a structure generated when a plate-shaped first current collecting member 70 is deformed to provide the convex part 72c. The convex part 72c on the upper surface 72a of the projection part 72 in the first current collecting member 70 is fit into the concave part 30c on the lower surface 30b of the positive terminal member 30. Because of this, the positioning of the positive terminal member 30 becomes easy. The joint strength between the positive terminal member 30 and the first current collecting member 70 can be improved. It should be noted that the structure other than the above may be the same as the structure of the battery 100.

As described above, as specific embodiments of the technique disclosed herein, those described in the following items are provided.

Item 1: An electrical storage device, including
an electrode body including a first electrode and a second electrode,
a case to accommodate the electrode body, and
a first current collecting member electrically connected to the first electrode,
wherein the case has a first wall,
the first wall has a first through hole,
the first current collecting member has a first region placed along the inner surface of the first wall,
a projection part, projecting to the first wall, is provided in the first region,
at least part of the projection part is placed in the first through hole,
the first current collecting member has a second region on the transverse side of the first region,
a first slit is formed between the first region and the second region,
the second region is placed along the inner surface of the first wall, and
the second region faces the inner surface of the first wall with an insulating member therebetween.

Item 2: The electrical storage device according to Item 1, wherein the insulating member is placed in the first slit.

Item 3: The electrical storage device according to Item 1 or 2,
wherein the first current collecting member has a third region on the opposite side of the second region with respect to the first region,
a second slit is formed between the first region and the third region,
the third region is placed along the inner surface of the first wall, and
the third region faces the first wall with the insulating member therebetween.

Item 4: The electrical storage device according to Item 3, wherein the insulating member is placed in the second slit.

Item 5: The electrical storage device according to any one of Items 1 to 4,
wherein the insulating member is placed between the first region and the first wall, further passes through the first through hole, and is in contact with the surrounding region of the first through hole on the outer surface of the first wall.

Item 6: The electrical storage device according to any one of Items 1 to 5, wherein the first wall has an almost rectangular shape in a planar view, and the length of the first region is greater than the longest length of the first through hole provided on the first wall in the longitudinal direction of the first wall.

Item 7: The electrical storage device according to any one of Items 1 to 6, wherein the insulating member is placed on the electrode body side of the projection part.

Item 8: The electrical storage device according to any one of Items 1 to 7, wherein a surface-treated part is provided in the vicinity of the periphery of the first through hole on the inner surface of the first wall, and the surface-treated part and the insulating member are in contact with each other.

Item 9: The electrical storage device according to Item 8, wherein the arithmetic mean roughness of the surface-treated part is two or more times greater than the arithmetic mean roughness of a part on the inner surface of the first wall except for the surface-treated part.

What is claimed is:

1. An electrical storage device, comprising
an electrode body comprising a first electrode and a second electrode,
a case that accommodates the electrode body, and
a first current collecting member electrically connected to the first electrode, wherein
the case has a first wall,
the first wall has a first through hole,
the first current collecting member has a first region placed along an inner surface of the first wall,
a projection part, projecting to the first wall, is provided in the first region,
at least part of the projection part is placed within the first through hole,
the first current collecting member has a second region on a transverse side of the first region,
a first slit is formed between the first region and the second region,
the second region is placed along the inner surface of the first wall, and
the second region faces the inner surface of the first wall with an insulating member therebetween.

2. The electrical storage device according to claim 1, wherein the insulating member is placed in the first slit.

3. The electrical storage device according to claim 1, wherein
the first current collecting member has a third region on an opposite side of the second region with respect to the first region,
a second slit is formed between the first region and the third region,
the third region is placed along the inner surface of the first wall, and
the third region faces the first wall with the insulating member therebetween.

4. The electrical storage device according to claim 3, wherein the insulating member is placed in the second slit.

5. The electrical storage device according to claim 1, wherein the insulating member is placed between the first region and the first wall, further passes through the first through hole, and is in contact with a surrounding region of the first through hole on an outer surface of the first wall.

6. The electrical storage device according to claim 1, wherein
the first wall has an almost rectangular shape in a planar view, and
a length of the first region is greater than a longest length of the first through hole provided on the first wall in a longitudinal direction of the first wall.

7. The electrical storage device according to claim 1, wherein the insulating member is placed on a side of the electrode body of the projection part.

8. The electrical storage device according to claim 1, wherein a surface-treated part is provided in a vicinity of a periphery of the first through hole on the inner surface of the first wall, and the surface-treated part and the insulating member are in contact with each other.

9. The electrical storage device according to claim 8, wherein an arithmetic mean roughness of the surface-treated part is two or more times greater than an arithmetic mean roughness of a part on the inner surface of the first wall, except for the surface-treated part.
